(19) United States
(12) Patent Application Publication
(10) Pub. No.: US 2024/0161644 A1
(43) Pub. Date: May 16, 2024

(54) Computer-Implemented System for Storing and Processing Data

(71) Applicant: Siemens Aktiengesellschaft, München (DE)

(72) Inventors: Rebecca Johnson, München (DE); Anja Simon, München (DE); Levent Sander, Weiden (DE); Michael Tau, Nürnberg (DE); Norbert Holler, Höchstadt/Aisch (DE); Georg Bodammer, München (DE)

(73) Assignee: Siemens Aktiengesellschaft, München (DE)

(21) Appl. No.: 18/550,318

(22) PCT Filed: Mar. 11, 2022
(86) PCT No.: PCT/EP2022/056290

§ 371 Date: Sep. 13, 2023

(30) Foreign Application Priority Data
Mar. 16, 2021 (DE) 10 2021 202 541.2

(51) Int. Cl. G09B 5/06

(52) U.S. Cl. CPC G09B 5/06

(57) ABSTRACT

Various embodiments include computer-aided systems and methods for training a user in conducting negotiations. An example method includes: providing data of a first type using recordings of real or virtual negotiations of one or more users with of one or more recording devices after corresponding computer-aided processing; and communicating the data of a first type to an artificial intelligence for generating data of a second and a third type. Data of a second and a third type are presented on an output device, which give the user a conception of the AI-calculated reaction and/or consequence of the user's recorded negotiation, subsequently and also in real time, during the ongoing negotiation.

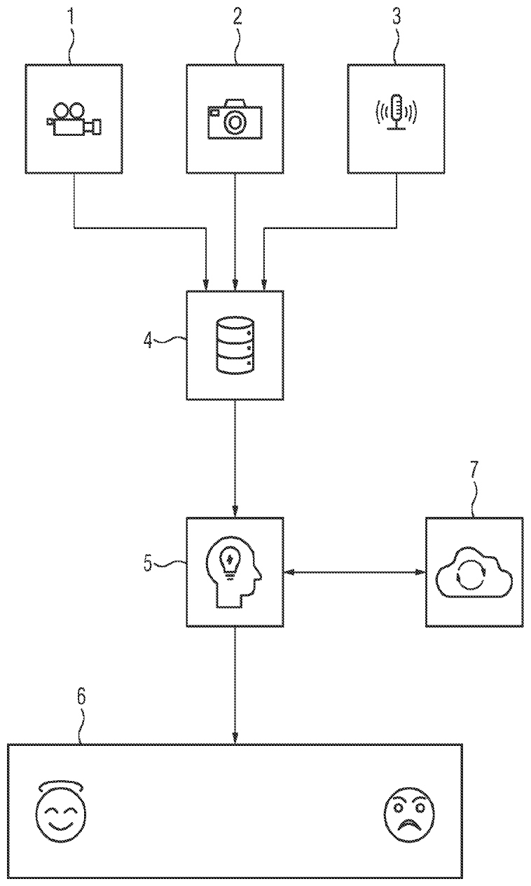

### CROSS-REFERENCE TO RELATED APPLICATIONS

This application is a U.S. National Stage Application of International Application No. PCT/EP2022/056290 filed Mar. 11, 2022, which designates the United States of America, and claims priority to DE Application No. 10 2021 202 541.2 filed Mar. 16, 2021, the contents of which are hereby incorporated by reference in their entirety.

### TECHNICAL FIELD

The present disclosure relates to data processing. Various embodiments of the teachings herein include computer-implemented methods and/or systems for storing and processing data, able to be acquired in an automated manner.

### BACKGROUND

Computer-implemented systems are known which have avatars, i.e. artificial persons or graphical representatives assigned to a player character in a virtual world. Secondly, typical training methods for training representatives, merchants and traders are known.

### SUMMARY

Teachings of the present disclosure include computer-implemented training programs which enable a person to be trained to conduct negotiations through playing on the basis of their own experiences. Various embodiments of these teachings include a computer-implemented system for storing and processing data, able to be acquired in an automated manner or manually, of a negotiation with one or more users via modules such as interfaces, recording device(s), processor(s), storage unit(s) and output device(s), comprising: at least one interface from at least one recording device to at least one storage unit for storing recorded raw data, at least one interface to at least one processor for retrieving and for processing the raw data in order to generate the data of a first type, at least one interface to at least one processor for retrieving and for processing the data of a first type in order to generate and/or configure data of a second type, at least one interface to a storage unit for storing the data of a second type, at least one interface to an output device suitable for reproducing the data of a second type, at least one interface to a processor configured such that it classifies and assesses the data of a second type with regard to the progress of the negotiation and configures and/or generates data of a third type therefrom, wherein data of a first type are data regarding the mood and/or the behavior patterns of one or more users, which, via at least one interface, are made available to at least one processor which has an AI or is connected to an AI, for the generation of the data of a second type by the AI, data of a second type are the results and/or solutions from this processing by means of AI in the form of one or more reaction(s) and/or one or more consequence (s), which were calculated from the data of a first type with the aid of artificial intelligence with regard to the predefined negotiation object, wherein at least one output device is provided which is suitable for presenting a reproduction of the data of a second type visually and/or by way of audio in real time and simultaneously, by means of data of the third type, for providing an assessment of the provided reactions and/or consequences as positive or negative with regard to the sought and predefined negotiation result, in a manner tailored to the respective user.

In some embodiments, the recording device is a camera.

In some embodiments, the recording device is a microphone.

In some embodiments, the processor configured to execute artificial intelligence and to configure and/or generate data of a second type comprises an interface to a processor configured to execute data mining.

In some embodiments, the processor configured to execute artificial intelligence and to configure and/or generate the data of a second type comprises an interface to a processor configured so as to execute “deep learning”.

In some embodiments, the processor configured to execute artificial intelligence and to configure and/or generate data of a second type comprises an interface to a processor configured so as to provide a natural language engine.

In some embodiments, the processor configured to execute artificial intelligence and to configure and/or generate data of a second type comprises an interface to a processor configured so as to provide a transformer.

In some embodiments, the processor configured to execute artificial intelligence and to configure and/or generate data of a second type comprises an interface to a processor configured so as to provide an NLP transformer.

In some embodiments, the processor configured to execute artificial intelligence and to configure and/or generate data of a second type comprises an interface to a processor configured so as to provide a Google BERT or a GPT-n transformer.

In some embodiments, the machine-to-machine communication is effected by way of an MQTT protocol.

In some embodiments, as data of a first type, static concepts also concomitantly influence the processing by the AI.

In some embodiments, the data of a second type are represented by an avatar on the output device.

As another example, some embodiments include a computer-aided method for training a user in conducting negotiations, the method comprising: providing data of a first type by means of recordings of real or virtual negotiations of one or more users by means of one or more recording devices after corresponding computer-aided processing, communicating the data of a first type to an artificial intelligence for generating data of a second and a third type, characterized in that data of a second and a third type are presented on an output device, which give the user a conception of the AI-calculated reaction and/or consequence of the user's recorded negotiation, subsequently and also in real time, during the ongoing negotiation.

In some embodiments, the method is carried out as a game with a points system.

In some embodiments, the method is carried out as a game with one or more avatars and/or chatbots.

### BRIEF DESCRIPTION OF THE DRAWINGS

The teachings are explained in greater detail below with reference to a figure showing one exemplary embodiment of a system incorporating teachings of the present disclosure.

### DETAILED DESCRIPTION

Various teachings of the present disclosure include computer-implemented systems and/or methods for storing and processing data, able to be acquired in an automated manner or manually, of a negotiation with one or more users via modules such as interfaces, recording device(s), processor(s), storage unit(s) and output device(s). For example, some embodiments include: at least one interface from at least one recording device to at least one storage unit for storing recorded raw data, at least one interface to at least one processor for retrieving and for processing the raw data in order to generate the data of a first type, at least one interface to at least one processor for retrieving and for processing the data of a first type in order to generate data of a second type, at least one interface to a storage unit for storing the data of a second type, at least one interface to an output device suitable for reproducing the data of a second type, at least one interface to a processor configured such that it classifies and assesses the data of a second type with regard to the progress of the negotiation and configures and/or generates data of a third type therefrom, wherein data of a first type are data regarding the mood and/or the behavior patterns of one or more users, which, via at least one interface, are made available to at least one processor which has an AI or is connected to an AI, for the generation of the data of a second type by the AI, data of a second type are the results and/or solutions from this processing by means of AI in the form of one or more reaction(s) and/or one or more consequence(s), which were calculated from the data of a first type with the aid of artificial intelligence with regard to the predefined negotiation object, wherein at least one output device is provided which is suitable for presenting a reproduction of the data of a second type visually and/or by way of audio in real time and simultaneously, by means of data of the third type, for providing an assessment of the provided reactions and/or consequences as positive or negative with regard to the sought and predefined negotiation result, in a manner tailored to the respective user.

As another example, some embodiments include a computer-aided method for training a user in conducting negotiations, the method comprising: providing data of a first type by means of recordings of real or virtual negotiations of one or more users by means of one or more recording devices after corresponding computer-aided processing, communicating the data of a first type to an artificial intelligence for generating data of a second and a third type, characterized in that data of a second and a third type are presented on an output device, which give the user a conception of the AI-calculated reaction and/or consequence of the user's recorded negotiation, subsequently and in particular also in real time, during the ongoing negotiation.

Using an artificial intelligence, repeatedly recurring behavior patterns of a negotiation that is in progress are able to be presented to a user in real time, such that the user can immediately learn from them. For this purpose, real or virtual negotiations are firstly interpreted accordingly by way of the observation and recording of their faces, gestures, facial expressions, or else their physical functionalities such as heartbeat, pulse, etc., and are assigned to different moods and/or patterns. These “data of a first type” are stored. Afterward, an artificial intelligence is trained with these “data of a first type” and calculates therefrom the “data of a second type”, which are correspondingly buffer-stored. From the representation of the AI-calculated “data of a second type” by way of a correspondingly configured output device, a user—in a manner similar to that when playing chess against the computer—can then hone their conducting of negotiations in real time and accordingly develop this further—wherever and whenever, but in practice also immediately.

“System” means a cohesive technical assemblage of various modules, devices, cameras, video recording devices, monitors, units, computers, processors, servers, clouds with corresponding interfaces for data transfer and corresponding connections, wireless or wired, which is suitable for carrying out the computer-aided method.

Unless indicated otherwise in the following description, the terms “carry out”, “calculate”, “computer-aided”, “compute”, “ascertain”, “generate”, “configure”, “reconstruct” and the like preferably relate to actions and/or processes and/or processing steps which change and/or generate data and/or which convert data into other data, wherein the data can be represented or be present in particular as physical variables, for example as electrical pulses. In particular, the expression “computer” should be interpreted as broadly as possible to cover in particular all electronic devices having data processing properties. Computers can thus be for example personal computers, servers, programmable logic controllers (PLCs), handheld computer systems, pocket PC devices, embedded systems, cloud and edge devices, IoT devices, network devices, gateway/bridge devices, mobile radio devices and other communication devices which can process data in a computer-aided manner, processors and other electronic devices for data processing.

In association with this disclosure, “computer-aided” means an implementation of the method in which in particular a processor performs at least one element of the method.

In some embodiments, the devices are for example devices of a technical system and/or of an industrial installation and/or of an automation network and/or of a manufacturing installation. In this case, the devices can be for example field devices or can be devices in the Internet of Things, which in particular are also a node of a distributed database system. Nodes can for example also comprise at least one processor in order e.g. to execute their computer-implemented functionality.

A “recording device” means for example a camera, a video camera, a 3D camera, a microphone and/or a combination of a plurality of individual devices, which can be used to record a negotiation really taking place with one or more users. The sensor-based raw data extractable from this device or these devices are buffer-stored in a storage unit via an interface before they are retrieved by a processor or computer suitably configured for this and are transformed into digitally processable data of a first type.

Virtually designed negotiations can also supply sensor-based raw data. Given suitable programming and/or setting of the recording devices, this technical set-up makes it possible to generate the data in real time and simultaneously make the data available to the processor(s) in order that the method can proceed, with the result that in a matter of seconds or even faster still, the user of the system immediately has feedback, “Oops, something is wrong there” or “keep it up!”. The computer-implemented system disclosed here for the first time is therefore the first that can intervene in the dynamics of an ongoing negotiation and can also crucially speed up and/or influence the latter. Communication allowing understanding between the partners can be optimized as a result. Not least, feedback about misunderstandings can also prevent “talking past one another”.

“Output and/or display device” means a device having an imaging component, such as a screen, a monitor or the like.

In association with this disclosure, a “computer” means for example a computer (system), a client, a smartphone, a device or a server. Alternatively, a computer can mean a node of a distributed database system. In other words, a device can mean a node of a cloud or of a distributed database system.

Data of a first type arise from sensor-based raw data of the recording devices. Said raw data can be generated for example directly by a device or module of the system and/or from a measurement and/or a recording, such as, for example, a pulse, heartbeat and/or blood pressure measurement of the user during the recorded negotiation really taking place, a microphone, a loudspeaker, a video camera and/or a photographic camera. Furthermore, raw data from a memory pulse tracker, a heart rate monitor—for example ECG-like—and/or in the form of a smartwatch, a “perspiration secretion” measuring device, general “tracking” sensor equipment—such as respiratory sound recordings, etc., can also be used to generate sensor-based raw data. These raw data are made available to a processor via a suitable interface, and said processor processes them to form “data of a first type” by means of face recognition, pattern recognition, etc. The raw data contain for example data pertaining to persons, postures, movements and/or faces including the facial expressions, gestures, speech, content of speech, manner of speaking, in which case for example an assigned mood and/or an assigned pattern matching the respective raw data are/is then ascertained in this respect in the “data of a first type”.

“Data of a second type” are the results of the processing of the data of a first type by means of artificial intelligence—AI—by way of data mining, pattern recognition, deep learning, NLP transformer with regard to the objective—tailored to the respective user of the system—in relation to achieving a predefined negotiation result. These results, “data of a second type”, are reproduced in the form of solutions representing reactions and/or consequences. By way of example, a recording device recognizes that a negotiation partner is offended, and from that the AI calculates “withdrawal” of the offended negotiation partner, which e.g. is represented by way of an avatar and is classified as negative in the assessment by way of data of the third type. Conversely, by way of a recording device, the system can recognize a compliment and thereby reproduce an open reaction exhibiting readiness to negotiate on the part of an avatar or chatbot thus addressed, which reaction is then rated positively by the system.

The data of a second type are the solutions which were generated by the processing by means of AI. They are represented graphically by way of an output device, such as a monitor, in which case for example a 2- or 3-dimensional avatar that presents these solutions to the user in the form of data of a first type effects the graphical representation. In this regard, an avatar can then reproduce annoyance, rage, pleasure, surprise, making concessions, etc., in just the same way as these moods are obtainable from the sensor-based raw data of the real or virtual negotiation by way of procedural processing in the form of the data of a first type. However, the representation can be effected equally well by way of signals, e.g. optical and/or acoustic, by way of vibrations, by way of smell, a chatbot, an audio output, texts, computer signals, and for example also color hues.

The “data of a third type”, which undertake an assessment of the data of a second type including reactions and consequences of the recorded negotiation situation, can be embodied for example as a simple points system. A plus point for a compliment that puts a negotiation partner in a better frame of mind or mood, as a result of which this negotiation partner is then prepared to pay a higher price and/or not yet break off the negotiation straightaway, etc. The data of a third type are also reproduced visually and/or through audio by the output device; here, too, it is possible to use an avatar, a chatbot that is a referee or adjudicator, for example.

In association with this disclosure, a “module” or a “unit” can be understood to mean for example a processor and/or a storage unit for storing raw data and also data of a first, second and/or third type and/or program code. By way of example, the processor is specifically designed to execute the program code in such a way that the processor executes functions, for implementing or realizing a system incorporating teachings of the present disclosure or parts thereof or one or more of the methods described herein.

The respective modules can for example also be embodied as separate or independent modules. For this purpose, the corresponding modules can comprise further elements, for example. These elements are for example one or more interfaces (e.g. database interfaces, communication interfaces—e.g. network interface, WLAN interface) and/or an evaluation unit (e.g. a processor) and/or a storage unit. By means of the interfaces, for example, data can be exchanged (e.g. received, communicated, transmitted or provided). By means of the evaluation unit, data can be compared, checked, processed, assigned or calculated for example in a computer-aided manner and/or in an automated manner. By means of a storage area, data can be stored, retrieved or provided for example in a computer-aided manner and/or in an automated manner.

In association with this disclosure, “provide”, in particular with regard to data, metadata and/or other information, can be understood to mean for example computer-aided providing. The providing is effected for example via an interface (e.g. a device interface, a database interface, a network interface, an interface to a storage unit). Via said interface, for example, during providing, corresponding data and/or information can be communicated and/or transmitted and/or retrieved and/or received. In association with the invention, “provide” can also be understood to mean for example loading or storing, for example of a transaction with corresponding data. “Provide” can for example also be understood to mean transferring (or transmitting or communicating) corresponding data from one node to another node.

In association with this disclosure, a “processor” can be understood to mean for example a machine or an electronic circuit. A processor may be in particular a central processing unit (CPU), a microprocessor or a microcontroller, for example an application-specific integrated circuit or a digital signal processor, possibly in combination with a storage unit for storing program instructions, etc. A processor can also be, for example, an IC (Integrated Circuit), in particular an FPGA (Field Programmable Gate Array), a PLD (Programmable Logic Device) or an ASIC (Application-Specific Integrated Circuit), or a DSP (Digital Signal Processor) or a GPU (Graphic Processing Unit) or an AI accelerator (e.g. Neural Processing Unit). A processor can also be understood to mean a virtualized processor, a virtual machine or a soft CPU. It can for example also be a programmable processor, which is equipped with configuration steps for performing the method according to the invention mentioned or is configured with configuration steps such that the programmable processor implements one or more elements of a method, a component, a module, or other aspects and/or partial aspects of the teachings herein.

In the present case, “data mining” denotes the systematic application of statistical methods to the data of a first type, where cross-connections and trends are newly created and/or recognizable. The process of “data mining” comprises processing and evaluation of the data of a first type in order to obtain knowledge from the data of a first type. Data mining in particular also serves for finding new patterns, for recognizing systematic errors during the generation of first data, for example in the speech recognition and/or during the assignment of feelings to the facial recognition. “Data mining” is thus understood to mean the systematic application of computer-aided methods in order to find patterns, trends and/or relationships in existing data pools.

In the present case, “pattern recognition” denotes the computer-aided capability of recognizing regularities, repetitions, similarities and/or conformities to laws in an amount of data.

“Artificial intelligence” denotes applications in which suitably configured processors and/or computers make available problem solutions as output from data and objectives as input by way of iterative computer-aided methods. In this case, an artificial intelligence generally makes use of a neural network, which comprises nodes connected by paths and is constructed in layers that follow a hierarchy.

In the context of AI, “deep learning” denotes a machine learning method that uses artificial neural networks (ANNs) having numerous interlayers—“hidden layers”—between input layer and output layer and thereby forms a comprehensive internal structure. Deep learning is used in speech and/or facial recognition, for example, because the latter can be formulated by means of mathematical rules only with difficulty.

By way of example, the recognition and retrievable storage of sensor-based “raw data” such as facial expressions, handwriting, speech, etc., which initially exist only as a collection of image points, require a hierarchy of concepts in order that the sensor-based raw data are combined to form an image and subsequently then also to form a mood and/or are stored accordingly in this way. In the case of deep learning, one or more self-adaptive algorithms in the context of a model are used to determine for example what concepts are able to be used for explaining the relationships between the sensor-based raw data present. This revision takes place in the so-called hidden layers, and the reason why they are called that is because they have neither data inputs—input—nor data outputs—output—but rather work completely within the AI.

During the processing of the raw data from the recording device(s) by means of a corresponding computer, it is therefore indeed also envisaged and advantageous to use AI in order to recognize the mood, the behavior patterns, etc., and to store or to transfer same as data of a first type.

During the generation of the data of a second type, which in practice implement the training of the users by way of the reproduction, AI is indispensable and essential, however.

The figure shows modules and devices 1 to 3, which make recordings of a negotiation really taking place or taking place virtually. From these sensor-based raw data, in the module 4 comprising at least one processor and a storage unit, data of a first type are generated, which reproduce the recordings and an analysis of the state of mind, the emotions and pattern recognition in the dynamics of the recorded negotiation.

The module 4, via a suitable interface, provides these data to the module 5, which has an artificial intelligence. The data of a first type are processed there by way of, for example, a “Natural Language Engine”, an NLP transformer, for example also by means of zero-shot learning techniques, i.e. machine learning tools that cope with small data sets, such as e.g. Google BERT or GPT-3.

By way of the module 5 having an AI, in order to generate the data of a second type by way of the AI and/or by way of further storage units, clouds and/or databases, various extensions can concomitantly influence the calculations and/or be made usable, such as e.g. raw material strategies, commodity strategy, market information, knowledge databases such as Wikipedia, or Siemens Wiki, real practical experiences of colleagues, and also cost breakdowns of specific commodities and/or material fields.

At that point the possible extensions of the system are arbitrary; depending on the concrete case, data can be retrieved from various databases and can influence the generation of the data of a second type by way of the module 5.

A “transformer” is a method by which a computer can translate one string of characters into another string of characters. This can be used e.g. to translate text from one language into another. For this purpose, a transformer is trained on a large amount of example data by means of machine learning before the trained model can then be used for the translation. In particular, transformers belong to the deep learning architectures. Transformers were published in 2017 in the course of the Conference on Neural Information Processing Systems.

In this case, “GPT-n” stands for a generative pretrained transformer that includes an autoregressive language model that uses deep learning to create a humanlike text. In this case, GPT-3 denotes the third generation of the GPT-n series, developed by Open AI and used exclusively by Microsoft.

The module 5 communicates for example with one or more processors and/or one or more storage units in a cloud 7 in order to provide solutions for generating data of a second type. In this case, the machine-to-machine communication can be effected by way of an MQTT protocol, for example. In the module 5, if appropriate after communication with the cloud 7 and from the input supplied by the data of a first type from the module 4, the data of a second and third type are calculated and generated, which are finally presented and/or output in the output device 6, for example by way of an avatar.

From the data of a first type, the module 5 can recognize situations and make available possible reactions and/or consequences as to how the negotiation partners react thereto. In this regard, the module 5 recognizes for example
compliments during a negotiation, such as e.g. “ . . . that is a nice carpet”,
insults, such as e.g. “ . . . this room looks cheap”,
excessively long pauses in speaking during the negotiation,
price indications such as e.g. “ . . . I'm prepared to pay 500 Euro”,
time limits, such as e.g. “ . . . I have to catch a flight in 12 hours . . . ”, and/or
ultimatums “ . . . shake on it now and I will give you 200 Euro . . . ”.

The module 5 can thus train the connected or integrated AI so that the latter calculates one or more possible reaction(s) to these situations.

Furthermore, it is provided that by way of the recording devices 1 to 3, static concepts are also made available to the module 5 and the AI as data of a first type, for example the outward first impression of the trader or potential buyer, such as age, gender, clothing—distinguished, fashionable, shabby, etc. These impressions can also be acquired in an automated manner by way of object recognition and lead for example to a starting price proposed by the avatar and guided by the trader's clothing.

“Cloud” denotes an IT infrastructure that is available via the Internet or an intranet, for example. It generally comprises storage units, computing power, processors, neural networks and/or application software. A cloud application is a program which is at least not completely managed on the local computer of a user, but rather at least partly on a server.

“MQTT” protocol denotes the “Message Queueing Telemetry Transport” network protocol, which makes it possible to transfer telemetry data in the form of messages between devices, despite long delays or restricted networks.

The data of a second and third type generated by the module 5, which communicates with the cloud 7, are finally provided to the output and/or display device 6, which reproduces and presents one or more avatars, which represent reactions and/or consequences, and also a ranking of the assessment of the users' actions recorded by way of the modules 1 to 3. In this case, the data of a third type can be represented by way of a simple points system, for example.

The systems and the methods incorporating teachings of the present disclosure make available for the first time a system in the form of a computer game using which merchants, traders, salespeople and negotiators in general, without complication, can obtain results while a negotiation is still proceeding, and can be trained in a manner not linked to time and location, but primarily in real time, during an ongoing negotiation.

What is claimed is:

1. A computer-implemented system for storing and processing data of a negotiation with one or more users, the system comprising:
a recording device providing raw data for storage in a memory;
a first processor in communication with the memory for retrieving and for processing the raw data to generate first type data;
a second processor for retrieving and for processing the first type data using artificial intelligence (AI) in order to generate and/or configure second type data;
an output device suitable for reproducing the second type data visually and/or audibly in real time and/or simultaneously;
a third processor for classifying and assessing the second type data with regard to progress of a negotiation and generating third type data therefrom; wherein
a first type data indicate a mood and/or a behavior pattern of a user;
a second type data include results and/or solutions in the form of a reaction and/or a consequence calculated using AI with regard to the predefined negotiation object;
the third type data provides an assessment of the provided reactions and/or consequences as positive or negative with regard to the sought and predefined negotiation result, in a manner tailored to the respective user and is displayed to the user with the output device.

2. The system as claimed in claim 1,
wherein the recording device comprises a camera.

3. The system as claimed in claim 1, wherein the recording device comprises a microphone.

4. The system as claimed in claim 1, wherein the second processor comprises an interface to a further processor configured to execute data mining.

5. The system as claimed in claim 1, wherein the second processor comprises an interface to a further processor configured to execute “deep learning”.

6. The system as claimed in claim 1, wherein the second processor comprises an interface to a further processor configured to provide a natural language engine.

7. The system as claimed in claim 1, wherein the second processor comprises an interface to a further processor configured to provide a transformer.

8. The system as claimed in claim 1, wherein the second processor comprises an interface to a further processor configured to provide an NLP transformer.

9. The system as claimed in claim 1, wherein the second processor comprises an interface to a further processor configured to provide a Google BERT or a GPT-n transformer.

10. The system as claimed in claim 1, wherein the machine-to-machine communication uses an MQTT protocol.

11. The system as claimed in claim 1, wherein processing using the AI include influence by static concepts.

12. The system as claimed in claim 1, wherein the data of a second type are represented by an avatar on the output device.

13. A computer-aided method for training a user in conducting negotiations, the method comprising:
providing data of a first type using recordings of real or virtual negotiations of one or more users with of one or more recording devices after corresponding computer-aided processing; and
communicating the data of a first type to an artificial intelligence for generating data of a second and a third type;
wherein data of a second and a third type are presented on an output device, which give the user a conception of the AI-calculated reaction and/or consequence of the user's recorded negotiation, subsequently and also in real time, during the ongoing negotiation.

14. The method as claimed in claim 13,
carried out as a game with a points system.

15. The method as claimed in claim 13, carried out as a game with one or more avatars and/or chatbots.
